(19) United States
(12) Patent Application Publication
(10) Pub. No.: US 2007/0242026 A1
(43) Pub. Date: Oct. 18, 2007

(54) APPARATUS AND METHOD OF PULSE GENERATION FOR ULTRA-WIDEBAND TRANSMISSION

(75) Inventors: David Jonathan Julian, San Diego, CA (US); Chong U. Lee, San Diego, CA (US); Amal Ekbal, San Diego, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 11/696,135

(22) Filed: Apr. 3, 2007

Related U.S. Application Data
(60) Provisional application No. 60/792,028, filed on Apr. 14, 2006.

(51) Int. Cl. G09G 3/36

(52) U.S. Cl. 345/100

(57) ABSTRACT

Aspects include methods and apparatuses for generating pulses in an ultra-wideband transmission. For example, some aspects include a method of providing a signal comprising at least one pulse. The method includes generating a first signal, generating at least one pulse based on at least one slope of said first signal, and transmitting said at least one pulse over a wireless channel. Other aspects include apparatus and devices for generating pulses.

### CROSS REFERENCE TO RELATED APPLICATIONS

Claim of Priority Under 35 U.S.C. §119

The present application for patent claims priority to U.S. Provisional Patent Application No. 60/792,028 (Attorney Docket No. 050882P1), entitled “LOW POWER LOW COMPLEXITY PULSE GENERATION FOR UWB TRANSMISSION,” filed Apr. 14, 2006, assigned to the assignee hereof and hereby expressly incorporated by reference herein.

### BACKGROUND

1. Field

This application relates generally to communications, and more specifically, to ultra-wide band communication.

2. Background

Ultra-wide band (UWB) technology enables wireless communications between devices. UWB technology may be employed for a variety of applications associated with wireless communication networks, for example, in personal area network (“PAN”) or body area network (“BAN”). Many methods of generating wide-band signals may be too complex, may use too much power, or may otherwise be unsuitable for some applications. Thus, a need exists for alternative methods and apparatuses for generating signals suitable for use in UWB applications.

### SUMMARY

A summary of sample aspects of the disclosure follows. For convenience, one or more aspects of the disclosure may be referred to herein simply as “some aspects.”

System, method, and devices of the invention each have several aspects, no single one of which is solely responsible for its desirable attributes. Without limiting the scope of this invention as expressed by the claims which follow, its more prominent features will now be discussed briefly. After considering this discussion, and particularly after reading the section entitled “Detailed Description” one will understand how the features of this invention provide advantages that include a low power, low complexity pulse generator for use, for example, in a UWB system.

Some aspects include a method of providing a signal comprising at least one pulse. The method includes generating a first signal, generating at least one pulse based on at least one slope of said first signal, and transmitting said at least one pulse over a wireless channel. Other aspects include apparatus and devices for generating pulses. For example, some aspects include devices such as headsets, watches, and medical devices configured to use such methods and apparatuses for generating pulses.

### BRIEF DESCRIPTION OF THE DRAWINGS

FIG. 1 is a block diagram illustrating an example network of wirelessly connected devices.

FIG. 2 is a block diagram illustrating an example of a wireless device such as illustrated in FIG. 1.

FIG. 3 is a timeline illustrating the transmit/receive duty cycle of an example of device such as illustrated in FIG. 2.

FIG. 4 is a block diagram illustrating a transmitter of a device such as illustrated in FIG. 2.

FIG. 5 is a block diagram illustrating an example of a pulse generator such as illustrated in FIG. 4.

FIG. 6 is a graphical illustration of the intermediate and output signals of the pulse generator of FIG. 5.

FIG. 7 is a block diagram illustrating an example of modulation in a transmitter such as illustrated in FIG. 4.

FIG. 8 is a block diagram illustrating another example of modulation in a transmitter such as illustrated in FIG. 4.

FIG. 9 is a flowchart illustrating one example of a method of generating pulses such as in the pulse generator of FIG. 5.

FIG. 10 is a flowchart illustrating in more detail one example of a method of generating pulses such as in the pulse generator of FIG. 5.

FIG. 11 is a block diagram illustrating an example of a device including a pulse generator

### DETAILED DESCRIPTION

The following detailed description is directed to certain specific aspects of the invention. However, the invention can be embodied in a multitude of different ways as defined and covered by the claims. It should be apparent that the aspects herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects concurrent channels may be established based on pulse repetition frequencies. In some aspects, concurrent channels may be established based on time hopping sequences. In some aspects, concurrent channels may be established based on pulse repetition frequencies and time hopping sequences.

In a low costs/low complexity device, particularly one having low power consumption, generating suitable pulses for a pulse-based ultra-wide band (UWB) system can have a relatively high complexity/power cost. Accordingly, low complexity, low power, techniques are needed for generating pulses in such UWB systems.

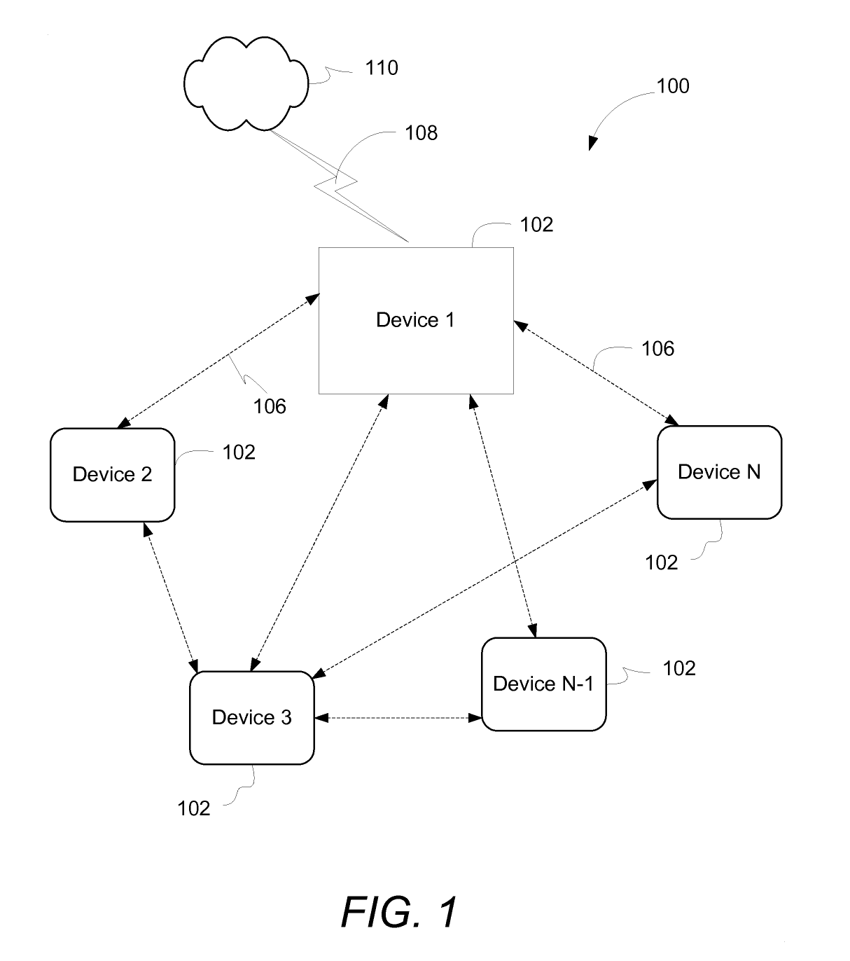

FIG. 1 is a block diagram illustrating an example network 100 of wirelessly connected devices 102 (e.g., Device 1, . . . , Device N). The network 100 may comprise one or more of a personal area network (PAN) system and/or a body area network (BAN). The network 100 may optionally include one or more devices 102 that comprise a longer range, e.g., mobile telephone or other network interface and other device, each of which is configured to communicate over a wireless link 106. Each device 102 may be configured to communicate over the links 106 and at least one other data communications link, e.g., via any suitable wireless or wired network link. The devices 102 may comprise devices such as headsets and watches (or other portable devices configured to display information such as caller id from a phone and/or messages (or portions thereof) such as email, short message system (SMS) messages, or any other type of data, including data received over the wireless links 106 and 108. Each of the devices 102 may communicate with one, two, or any number of the other devices 102.

As discussed further below, in some aspects the communications link 106 a pulsed-based physical layer. For example, the physical layer may utilize ultra-wideband pulses that have a relatively short length (e.g., on the order of a few nanoseconds) and a relatively wide bandwidth. In some aspects, an ultra-wide band may be defined as having a fractional bandwidth on the order of approximately 20% or more and/or having a bandwidth on the order of approximately 500 MHz or more. The fractional bandwidth is a particular bandwidth associated with a device divided by its center frequency. For example, a device according to this disclosure may have a bandwidth of 1.75 GHz with center frequency 8.125 GHz and thus its fractional bandwidth is 1.75/8.125 or 21.5%.

Those skilled in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

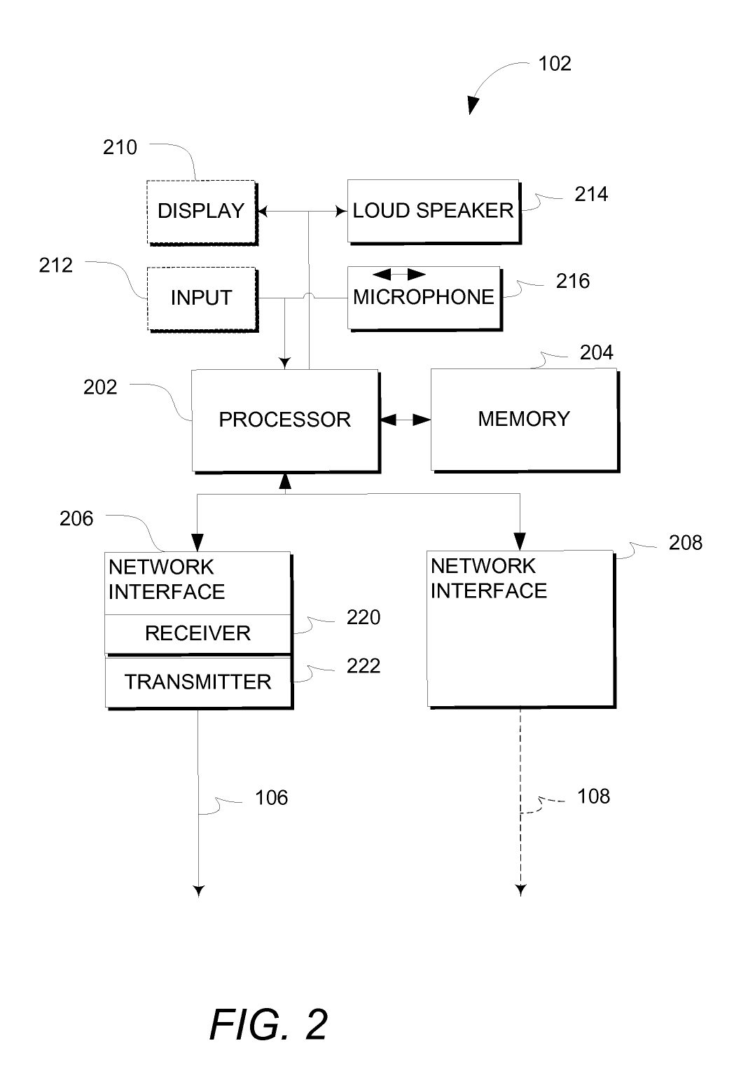

FIG. 2 is a block diagram illustrating an example of a wireless device 102. The device 102 includes a processor 202 that is in communication with a memory 204 and a network interface 206 for communicating via the wireless link 106. Optionally, the device 102 may also include one or more of a display 210, a user input device 212 such as a key, touch screen, or other suitable tactile input device, a loudspeaker 214 comprising a transducer adapted to provide audible output based on a signal received over the wireless link 106 and/or a microphone 216 comprising a transducer adapted to provide audible input of a signal that may be transmitted over the wireless link 106. For example, a watch may include the display 210 adapted to provide a visual output based on a signal received via the wireless communication link. A medical device may include one or more input devices 212 that include a sensor adapted to generate sensed signals to be transmitted via the wireless communication link 106.

The network interface 206 may include any suitable antenna (not shown), a receiver 220, and a transmitter 222 so that the exemplary device 102 can communicate with one or more devices over the wireless link 106. Optionally, the network interface 206 may also have processing capabilities to reduce processing requirements of the processor 202.

Optionally, the device 102 may include a second network interface 208 that communicates over the network 110 via a link 108. For example, the device 102 may provide connectivity to the other network 110 (e.g., a wide area network such as the Internet) via a wired or wireless communication link. Accordingly, the device 102 may enable other devices 102 (e.g., a Wi-Fi station) to access the other network. In addition, it should be appreciated that one or more of the devices 102 may be portable or, in some cases, relatively non-portable. The second network interface 208 may transmit and receive RF signals according to the IEEE 802.11 standard, including IEEE 802.11(a), (b), or (g), the BLUETOOTH standard, and/or CDMA, GSM, AMPS or other known signals that are used to communicate within a wireless cell phone network. In addition, the second network interface 208 may comprise any suitable wired network interface such as Ethernet (IEEE 802.3).

The device 102 may comprise at least one of a mobile handset, a personal digital assistant, a laptop computer, a headset, a vehicle hands free device, or any other electronic device. In addition, the device 102 may comprise one or more of a biomedical sensor, biometric sensor, a pacemaker, or any other device for measuring or affecting a human body. In particular, the teachings herein may be incorporated into (e.g., implemented within or performed by) a variety of the devices 102. For example, one or more aspects taught herein may be incorporated into a phone (e.g., a cellular phone), a personal data assistant (“PDA”), an entertainment device (e.g., a music or video device), a headset (e.g., headphones, an earpiece, etc.), a microphone, a biometric sensor (e.g., a heart rate monitor, a pedometer, an EKG device, a keyboard, a mouse, etc.), a user I/O device (e.g., a watch, a remote control, a light switch, etc.), a tire pressure monitor, a computer, a point-of-sale device, an entertainment device, a hearing aid, a set-top box, or any other suitable device.

The components described herein may be implemented in a variety of ways. Referring to FIG. 2, the device or apparatus 102 is represented as a series of interrelated functional blocks that may represent functions implemented by, for example the processor 202, software, some combination thereof, or in some other manner as taught herein. For example, the processor 202 may facilitate user input via the input devices 212. Further the transmitter 222 may comprises a processor for transmitting that provides various functionality relating to transmitting information to another device 102. The receiver 220 may comprises a processor for receiving that provides various functionality relating to receiving information from another device 102 as taught herein.

As noted above, FIG. 2 illustrates that in some aspects these components may be implemented via appropriate processor components. These processor components may in some aspects be implemented, at least in part, using structure as taught herein. In some aspects a processor may be adapted to implement a portion or all of the functionality of one or more of these components. In some aspects one or more of the components represented by dashed boxes are optional.

In some aspects, the device or apparatus 102 may comprise an integrated circuit. Thus, the integrated circuit may comprise one or more processors that provide the functionality of the processor components illustrated in FIG. 2. For example, in some aspects a single processor may implement the functionality of the illustrated processor components, while in other aspects more than one processor may implement the functionality of the illustrated processor components. In addition, in some aspects the integrated circuit may comprise other types of components that implement some or all of the functionality of the illustrated processor components.

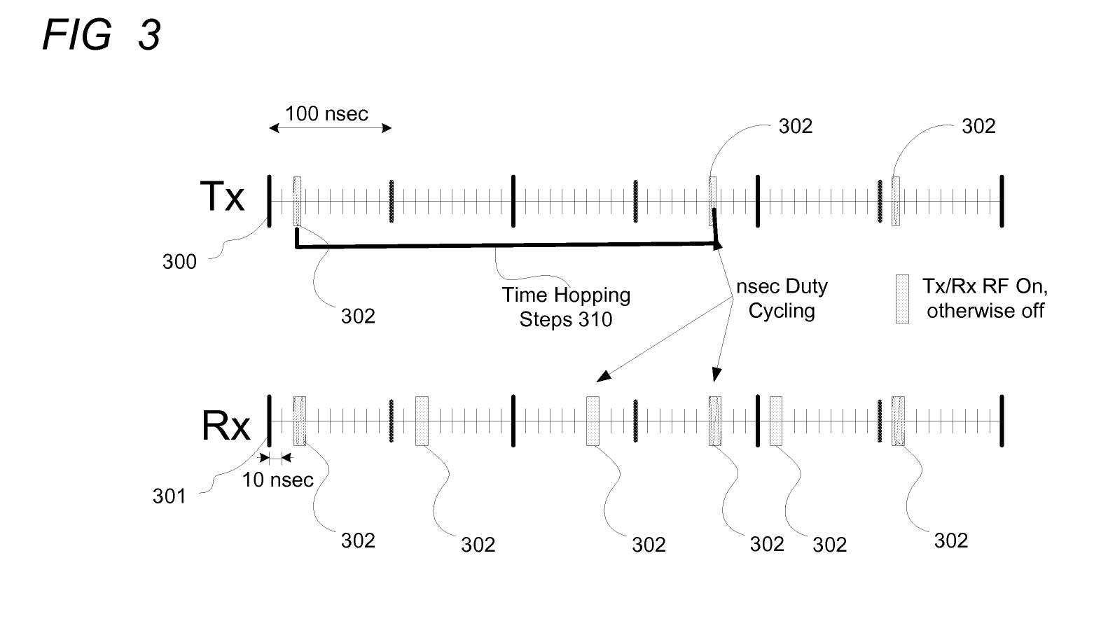

FIG. 3 illustrates timelines of the transmit/receive duty cycle of an example the device 102 using the link 106. Duty cycle refers to the portion or ratio of the transmitter “on” time on one or more carrier frequencies. Desirably for a low power device, the duty cycle of a pulsed UWB device is low because the transmitter is only on for the time to transmit each of the short pulses that make up a UWB signal. On each horizontal axis, the smallest divisions denote 10 ns, the largest divisions 200 ns and the intermediate size divisions denote 100 ns. The timeline 300 illustrates a transmit duty cycle of the transmitter 222 of the device 102. The timeline 301 illustrates a receiver duty cycle of the receiver 220 of the device 102. Blocks 302 along the timelines 300 and 301 represent time periods in which the transmitter 222 and the receive 220 respectively send and receive signals. As illustrated by the timeline 300, the transmitter 222 transmits in short pulses or bursts, e.g., on the scale of 10 nanoseconds (ns) time each. Each of the transmitted pulses 302 is separated from the previous pulse by a time hopping period 310. The pulses 302 act as a pulse carrier that is modulated with an information signal to be communicated via the link 302. The pulse carrier may be modulated by a modulation scheme such as pulse position modulation, pulse amplitude modulation, or transmitted reference modulation. Transmission and reception of such short pulses generally may require a relatively higher bandwidth, e.g., a UWB transmission in a bandwidth of (or a fraction of), for example, 500 MHz or more.

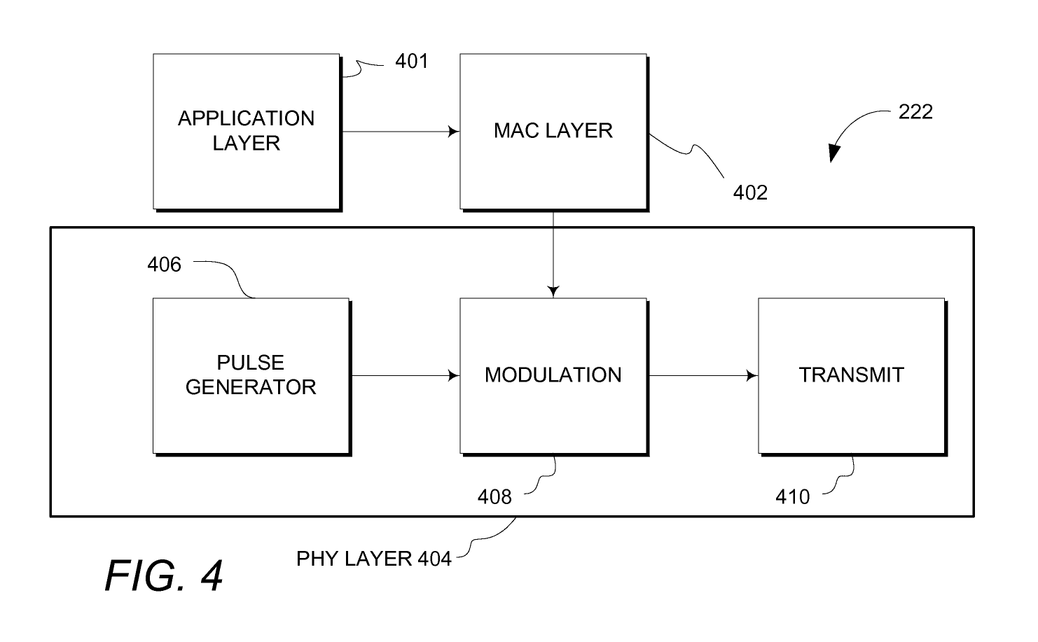

FIG. 4 is a block diagram illustrating an example of the transmitter 222 of the device 102. As would be apparent to one of skill in the art, in the illustrated block diagram of FIG. 4, logical modules of the device 102 are illustrated in terms of a layered, abstract description for a communications network. As noted below, each layer may comprise one or more logical modules that may be implemented in software, hardware, or any suitable combination of both. The transmitter 222 may include an application layer 401 that provides information to a data link or media access control (MAC) layer 402 for transmission, the media access control (MAC) layer 402 that receives data from the application layer 401 and provides it to a physical layer 404, and the physical (PHY) layer 404 that receives data from the MAC layer 402 and transmits the data over the wireless channel 106. In the illustrated transmitter 222, the PHY layer includes a pulse generator 406, a modulation block 408, and a transmit block 410. A phase locked loop (PLL) (not shown) may provide timing signals to the PHY layer. The pulse generator 406 generates waveforms such as Gaussian pulse waveforms. The modulation block 408 modulates the pulse signal based on an information signal provided by the MAC layer 402 using a scheme such as pulse position modulator, pulse amplitude modulation, or transmitted reference modulation. The transmit block 410 transmits the modulated pulse signal. Functions of the transmit block 410 may include amplifying the modulated pulse signal for transmission and providing the signal to an antenna.

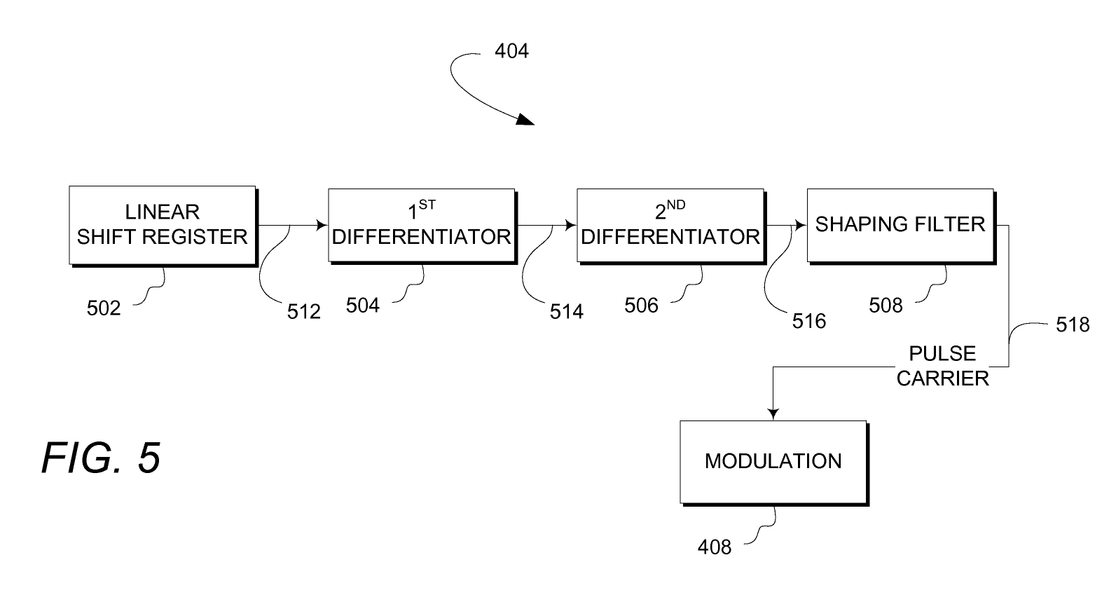

FIG. 5 is a block diagram illustrating an example of the pulse generator 406. The pulse generator 406 includes a linear shift register 502, a first differentiator 504, a second differentiator 506, and a shaping filter 508. The linear shift register 502 is configured to generate a pseudo-random sequence of binary values that defines a pseudo-random signal 512. The signal 512, which may define a square wave signal, is generally not suitable for direct transmission as its binary pulses have too large a period and/or are too narrow in bandwidth to directly define a UWB signal. Thus, according to some aspects, the pulse generator 504 performs a double differentiation of the signal 512 to first generate a half-wave pulse then a full-wave pulse of suitable bandwidth for a UWB transmission. The slew rate of the signal 512 thus at least partly defines the bandwidth of the signal. In particular, the pseudo-random signal 512 comprising the binary values is provided to a first differentiator 504 that generates a signal 514 indicative of a slope of the binary pseudo-random signal, e.g., the first differentiator 504 generates the signal 514 to be substantially the derivative of the signal 512. The second differentiator 506 receives the first derivative signal 514 and generates a pulse signal 516 that is indicative of a slope of the first derivative signal 514, e.g., the second differentiator 506 generates the signal 516 to be substantially the derivative of the signal 514 (and thus to be substantially the second derivative of the pseudo-random signal 512). The shaping filter 508 may be a simple band pass filter that rejects out-of-band signals to generate a pulse carrier signal 518 that may be providing the modulation block 408 of FIG. 4.

The illustrated pulse generator 406 can thus generate the pulses comprising a UWB signal using a relatively low complexity, low power circuit for use in, for example, low power, power limited (battery powered) devices. In addition, such pulses can be used for other types of pulse based radio devices such as radio frequency identification tags. The generated pulse signal can be applied to other low complexity techniques such as transmitted reference modulation schemes to provide a low-complexity and/or low-power transmitter 222.

The pulse signal 518 can be configured to have a specified time-hopping sequence or direct sequence pattern that depends on configured initial conditions and tap weights of the linear shift register 502. Thus, multiple UWB links can be configured using a particular linear shift register 502 with different configurations. The linear shift register 502 may comprise a square wave clock generator.

The transmitter 222 may employ a variety of wireless physical layer schemes, e.g., on top of the basic time-hopping scheme providing by the pulse generator 406. For example, the physical layer 404 of the transmitter 222 may utilize some form of CDMA, TDMA, OFDM, OFDMA, or other modulation and multiplexing schemes.

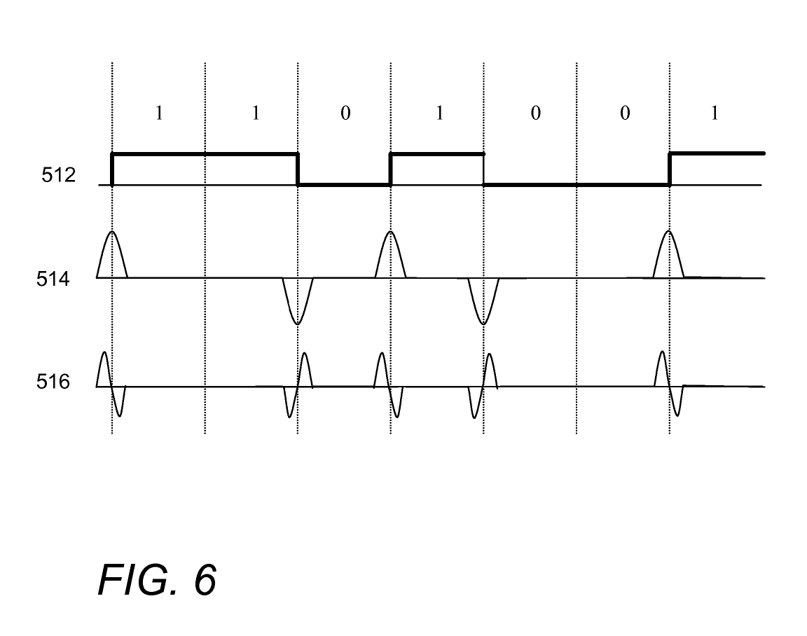

FIG. 6 is a graphical illustration of the intermediate and output signals of the pulse generator 406 of FIG. 5. The signal 512 output by the linear shift register 502 is illustrated along the top of the figure. The horizontal axis represents time and the vertical axis represents signal magnitude, e.g., voltage. As illustrated by the trace, the signal 512 comprises a series of ones (high magnitude) and zeros (low magnitude). The signal 512 of the illustration of FIG. 6 is an idealized square wave output. The linear shift register 502 may be configured to control the bandwidth of the pulse based on the slew rate of the linear shift register output. The signal 514 output by the first differentiator 504 comprises positive and negative pulses substantially corresponding to the positive and negative edges of the signal 512. The second differentiator 506 generates a zero mean pulse (e.g., a pulse having a first polarity followed by a pulse having the opposite polarity for substantially the same amount of time and with substantially the same amplitude.

In addition to the illustrated modulation 408 of FIG. 4, which modulates the output signal 518 of the pulse generator 406 based on a data signal such as that provided by the MAC layer 402, modulation of the signal for transmission may be performed at a number of different locations in the physical layer 404. For example, the initial conditions of the linear shift register 502 may be configured to be indicative of the data signal. In another example, the pulse generator 406 may include any suitable digital sequence generator including a convolutional encoder (not shown) in place of, or in addition to, the linear shift register 502. In some aspects, the modulation 408 may comprise multiplying the output of the pulse generator 406 by the data signal.

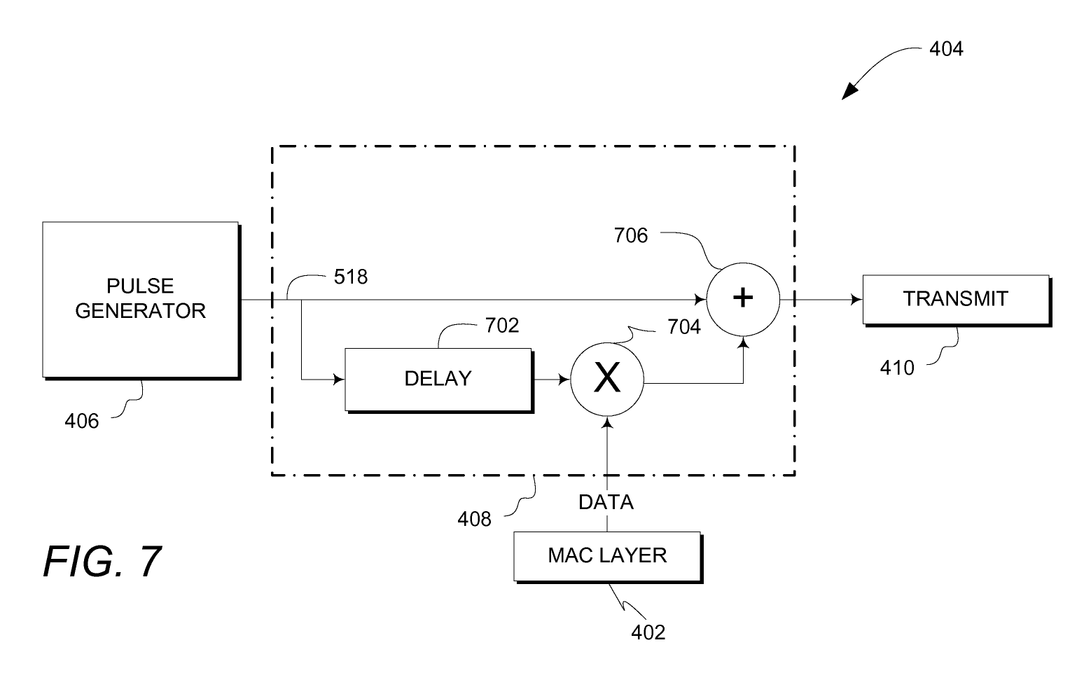

FIG. 7 is a block diagram illustrating an example of modulation in the physical layer 404. In particular, FIG. 7 illustrates the modulation 408 using a transmitted reference scheme. The output 518 of the pulse generator 406 is provided to a delay 702 whose output is modulated, e.g., flipped, based on a data signal (e.g., whether the data bit is one or zero) such as from the MAC layer 402. A combiner 706 combines the pulse signal 518 with the modulated and delayed version of the signal to generate the transmitted reference modulated signal for transmission by the transmit module 410.

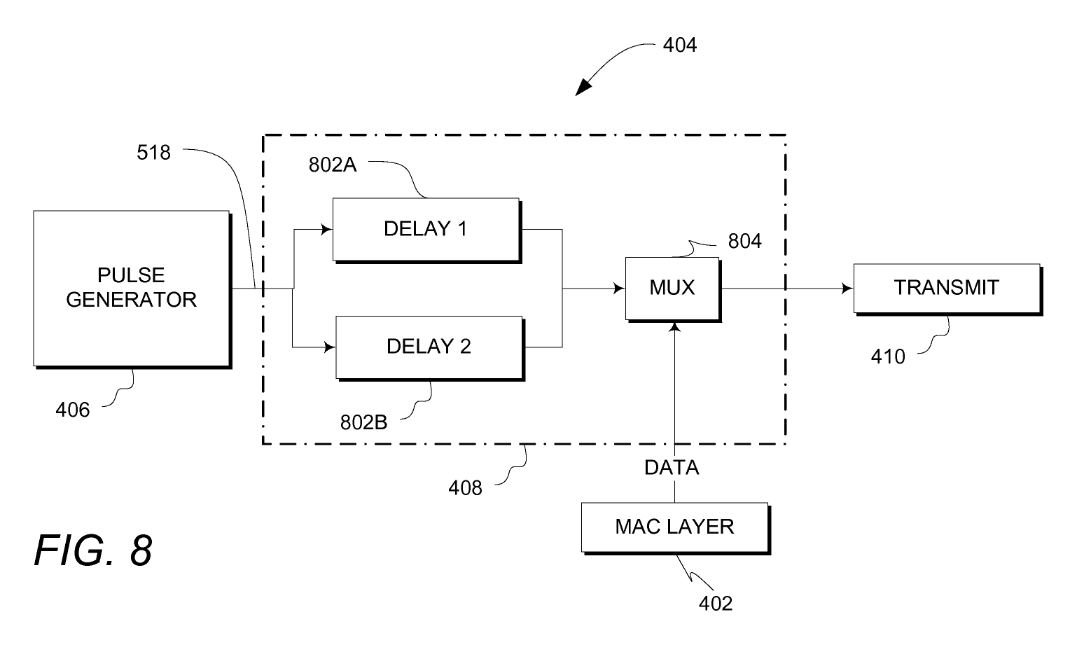

FIG. 8 is a block diagram illustrating another example of modulation in the physical layer 404. In particular, FIG. 8 illustrates the modulation 408 using a pulse position modulation scheme. The output 518 of the pulse generator 406 is provided to two delays 802A and 802B, which provide delayed versions of the signal 518 to a multiplexer (MUX) 804 which determines which delayed signal to transmit based on the data signal (e.g., whether the data signal value is one or zero).

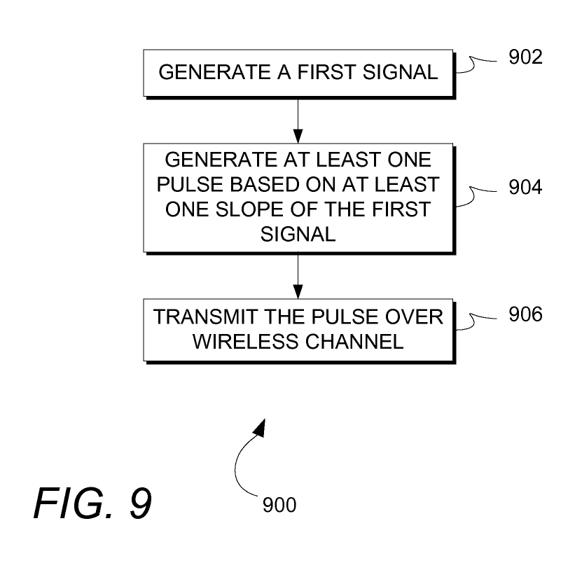

FIG. 9 is a flowchart illustrating one example of a method 900 of generating pulses such as in the pulse generator 404 of FIG. 5. The method 900 begins at a block 902 in which the pulse generator 404 generates a first signal. For example, the pulse generator 404 may comprise the linear shift register 502 of FIG. 5 that generates a substantially square wave signal. Next at a block 904, the pulse generator 404 generates at least one pulse based on at least one slope of the first signal. For example, the pulse generator 404 may comprise the differentiators 504 and 506 of FIG. 5 that generate a pulse based on the slope, e.g., a time differential, of the first signal. Proceeding to a block 906, the transmit block 410 of the transmitter 222 transmits the pulse, e.g., to another device 102 in the system 100. The method 900 may be repeated for each pulse or set of pulses in a transmit duty cycle.

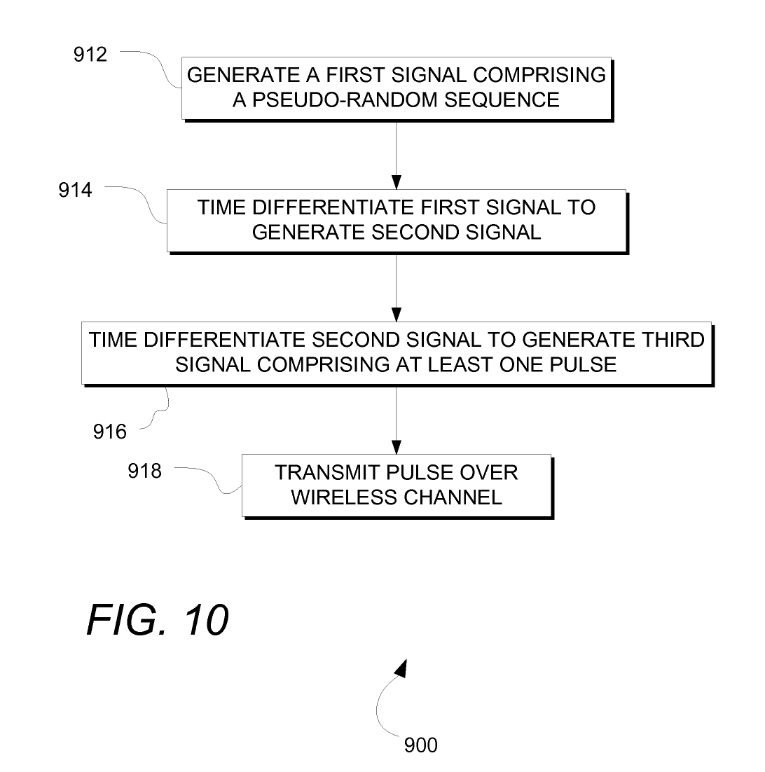

FIG. 10 is a flowchart illustrating in more detail one example of the method 900 of generating pulses such as in the pulse generator 404 of FIG. 5. The method 900 begins at a block 912 in which the pulse generator 404 generates generate a first signal comprising a pseudo-random sequence. For example, the pulse generator 404 may comprise the linear shift register 502 of FIG. 5 that generates the pseudo-random sequence. Next at a block 914, the pulse generator 404 time differentiates the first signal to generate second signal that is indicative of the slope (e.g., changes in the slope) of the first signal. For example, the pulse generator 404 may comprise the differentiator 504 of FIG. 5 that generates the second signal based on the time differential (e.g., the slope) of the first signal. Moving to a block 916, the pulses generator 404 time differentiates second signal to generate third signal comprising at least one pulse. For example, the pulse generator 404 may comprise the differentiator 506 of FIG. 5 that generates the third signal based on the time differential (e.g., the slope) of the second signal. Proceeding to a block 918, the transmit block 410 of the transmitter 222 transmits the pulse over the wireless channel 106, e.g., to another device 102 in the system 100.

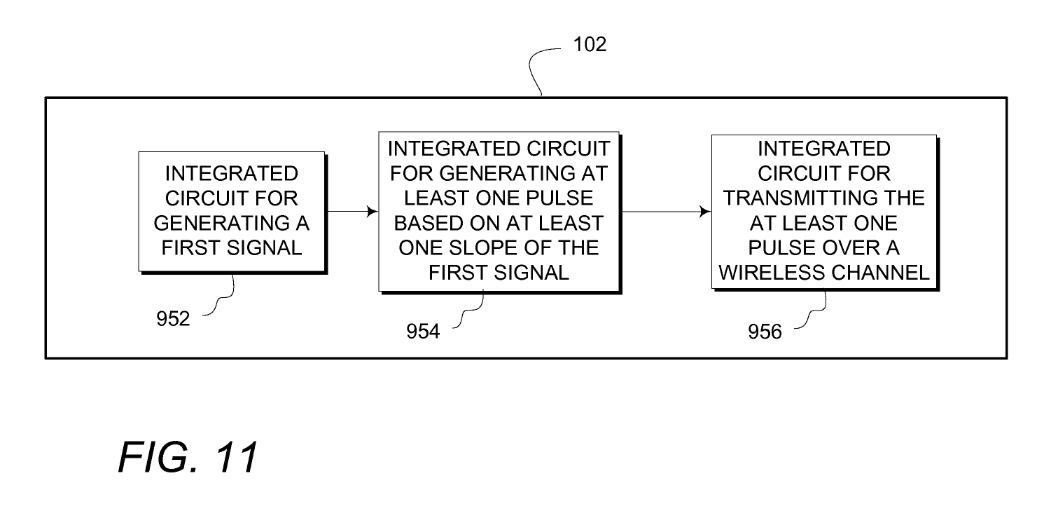

FIG. 11 is a block diagram illustrating an example of the device 102 that generates pulses using the method 900 of FIG. 10. In the illustrated example, the device 102 comprises a means or an integrated circuit (IC) 952 for generating a first signal. In some aspects, the IC 952 comprises the linear shift register 502 of FIG. 5. The device 102 also comprises a means or IC 954 for generating at least one pulse based on at least one slope of the first signal. In some aspects, the IC 954 comprises the differentiators 504 and 506 of FIG. 5. The device 102 also comprises a means or an IC 956 for transmitting the at least one pulse over a wireless channel. In some aspects, the IC 956 comprises the transmit module 410 of FIG. 4.

In view of the above, one will appreciate that the disclosure addresses how to generate pulses in a pulse based communication system, such as a UWB system. For example, the illustrated aspects provide a low complexity, low power method, and apparatus for generating pulses. Moreover, the use of a linear shift register according to some aspects provides a pseudo random sequence based signal that provides variability to pulses in a transmitted reference scheme that improves spectra emissions, e.g., reduces spectral lines.

Any illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is to be recognized that depending on the certain aspects, certain acts or events of any of the methods described herein can be performed in a different sequence, may be added, merged, or left out all together (e.g., not all described acts or events are necessary for the practice of the method). Moreover, in certain aspects, acts or events may be performed concurrently, e.g., through multi-threaded processing, interrupt processing, or multiple processors, rather than sequentially.

Those skilled in the art will recognize that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of this disclosure.

The steps of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

While the above detailed description has shown, described, and pointed out novel features of the invention as applied to various aspects, it will be understood that various omissions, substitutions, and changes in the form and details of the device or process illustrated may be made by those skilled in the art without departing from the scope of this disclosure. As will be recognized, the invention may be embodied within a form that does not provide all of the features and benefits set forth herein, as some features may be used or practiced separately from others. The scope of this disclosure is defined by the appended claims, the foregoing description or both. All changes which come within the meaning and range of equivalency of the claims are to be embraced within their scope.

What is claimed is:

1. A method of providing a signal comprising at least one pulse, comprising:
generating a first signal;
generating at least one pulse based on at least one slope of said first signal; and
transmitting said at least one pulse over a wireless channel.

2. The method of claim 1, wherein generating the first signal comprises generating a pseudo-random sequence.

3. The method of claim 1, wherein generating said first signal comprises generating at least one square wave.

4. The method of claim 1, wherein generating said at least one pulse comprises:
generating a second signal indicative of at least one slope of said first signal; and
generating a third signal comprising said at least one pulse indicative of a slope of said second signal.

5. The method of claim 4, wherein generating said second signal comprises calculating a differential of said first signal.

6. The method of claim 4, wherein generating said third signal comprises calculating a differential of said second signal.

7. The method of claim 4, wherein generating said second signal comprises generating a half-wave pulse.

8. The method of claim 4, wherein generating said third signal comprises generating a full-wave pulse.

9. The method of claim 1, wherein generating at least one pulse based on at least one slope of said first signal comprises generating the at least one pulse to correspond to at least one change in the at least one slope of the first signal.

10. The method of claim 1, wherein said at least one pulse substantially occupies an ultra-wide band.

11. The method of claim 1, wherein said at least one pulse comprises a pulse carrier signal.

12. The method of claim 1, further comprising modulating the at least one pulse with information for transmission.

13. The method of claim 12, wherein modulating the at least one pulse using at least one of pulse position modulation, pulse amplitude modulation, and transmitted reference modulation.

14. An apparatus for providing a signal comprising at least one pulse, comprising:
a first generator configured to generate a first signal;
a second generator configured to generate at least one pulse based on at least one slope of said first signal; and
a transmitter configured to transmit said at least one pulse over a wireless channel.

15. The apparatus of claim 14, wherein said first generator comprises a linear shift register configured to generate a pseudo-random sequence.

16. The apparatus of claim 14, wherein said first generator is configured to generate at least one square wave.

17. The apparatus of claim 14, wherein said second generator comprises:
a first differentiator configured to generate a second signal indicative of at least one slope of said first signal; and
a second differentiator configured to generate a third signal comprising said at least one pulse indicative of a slope of said second signal.

18. The apparatus of claim 17, wherein said first differentiator comprises a circuit configured to generate a differential of said first signal.

19. The apparatus of claim 18, wherein said second differentiator comprises a circuit configured to generate a differential of said second signal.

20. The apparatus of claim 18, wherein said first differentiator is configured to generate a half-wave pulse.

21. The apparatus of claim 18, wherein said second differentiator is configured to generate a full-wave pulse.

22. The apparatus of claim 14, wherein said second generator is configured to generate the at least one pulse to correspond to at least one change in the at least one slope of the first signal.

23. The apparatus of claim 14, wherein said at least one pulse occupies an ultra-wide band signal.

24. The apparatus of claim 14, wherein said at least one pulse comprises a pulse carrier signal.

25. The apparatus of claim 14, further comprising a modulator configured to modulate the at least one pulse with information for transmission.

26. The apparatus of claim 25, wherein the modulator is configured to modulate the at least one pulse using at least one of pulse position modulation, pulse amplitude modulation, and transmitted reference modulation.

27. An apparatus for providing a signal comprising at least one pulse, comprising:
means for generating a first signal;
means for generating at least one pulse based on at least one slope of said first signal; and
means for transmitting said at least one pulse over a wireless channel.

28. The apparatus of claim 27, wherein said means for generating a first signal comprises a linear shift register configured to generate a pseudo-random sequence.

29. The apparatus of claim 27, wherein said means for generating a first signal is configured to generate at least one square wave.

30. The apparatus of claim 27, wherein said second generating means comprises:
means for generating a second signal indicative of at least one slope of said first signal; and
means for generating a third signal comprising said at least one pulse indicative of a slope of said second signal.

31. The apparatus of claim 30, wherein said means for generating a second signal comprises means for generating a differential of said first signal.

32. The apparatus of claim 31, wherein said means for generating a third signal comprises means for generating a differential of said second signal.

33. The apparatus of claim 30, wherein said means for generating a second signal is configured to generate a half-wave pulse.

34. The apparatus of claim 30, wherein said means for generating a third signal is configured to generate a full-wave pulse.

35. The apparatus of claim 27, wherein said means for generating at least one pulse is configured to generate the at least one pulse to correspond to at least one change in the at least one slope of the first signal.

36. The apparatus of claim 27, wherein said at least one pulse substantially occupies an ultra-wide band.

37. The apparatus of claim 27, wherein said at least one pulse comprises a pulse carrier signal.

38. The apparatus of claim 27, further comprising means for modulating the at least one pulse with information for transmission.

39. The apparatus of claim 38, wherein the modulating means is configured to modulate the at least one pulse using at least one of pulse position modulation, pulse amplitude modulation, and transmitted reference modulation.

40. A computer-program product for communicating data, comprising:
computer-readable medium comprising codes executable by at least one computer to:
generate a first signal;
generate at least one pulse based on at least one slope of said first signal; and
transmit said at least one pulse over a wireless channel.

41. A headset for wireless communications, comprising:
a microphone adapted to provide sensed data;
a first generator configured to generate a first signal;
a second generator configured to generate at least one pulse based on at least one slope of said first signal; and
a transmitter configured to modulate the at least one pulse with information derived from the sensed data for transmission over a wireless communications link.

42. A watch for wireless communications, comprising:
a first generator configured to generate a first signal;
a second generator configured to generate at least one pulse based on at least one slope of said first signal;
a transmitter configured to transmit said at least one pulse over a wireless communication link; and
a display adapted to provide a visual output based on at least one pulse received via the wireless communication link.

43. A medical device for wireless communications, comprising:
a sensor adapted to provide sensed data;
a first generator configured to generate a first signal;
a second generator configured to generate at least one pulse based on at least one slope of said first signal; and
a transmitter configured to modulate the at least one pulse with information derived from the sensed data for transmission over a wireless communications link.
